(19) United States
(12) Patent Application Publication
(10) Pub. No.: US 2011/0105075 A1
(43) Pub. Date: May 5, 2011

(54) METHOD OF TRANSMITTING OR RECEIVING AN UPDATED WARNING MESSAGE IN MOBILE COMMUNICATION SYSTEM

(76) Inventors: Young-Dae Lee, Gyeonggi-Do (KR); Seung-June Yi, Gyeonggi-Do (KR); Sung-Duck Chun, Gyeonggi-Do (KR); Sung-Jun Park, Gyeonggi-Do (KR)

(21) Appl. No.: 13/000,532

(22) PCT Filed: Sep. 18, 2009
(86) PCT No.: PCT/KR09/05322

§ 371 Date: Dec. 21, 2010

Related U.S. Application Data
(60) Provisional application No. 61/098,661, filed on Sep. 19, 2008.

(30) Foreign Application Priority Data
Sep. 17, 2009 (KR) 10-2009-0088253

(51) Int. Cl. H04W 4/22

(52) U.S. Cl. 455/404.1

(57) ABSTRACT

Disclosed is a method of receiving or transmitting an updated warning message in wireless communication system. More particularly, a terminal (UE), which attempts to receive the warning message, receives a broadcast control channel (BCCH) within a corresponding cell, obtains update information for the warning message through the received BCCH, determine whether the warning message has been updated according to the obtained update information, and receives the updated warning message only when the warning message is determined to be updated.

### TECHNICAL FIELD

The present invention relates to a method of receiving or transmitting an updated warning message in wireless communication system. More particularly, a terminal (UE), which attempts to receive the warning message, receives a broadcast control channel (BCCH) within a corresponding cell, obtains update information for the warning message through the received BCCH, determine whether the warning message has been updated according to the obtained update information, and receives the updated warning message only when the warning message is determined to be updated.

### BACKGROUND ART

FIG. 1 shows an exemplary network structure of an Evolved Universal Mobile

Telecommunications System (E-UMTS) as a mobile communication system to which a related art and the present invention are applied. The E-UMTS system is a system that has evolved from the UMTS system, and its standardization work is currently being performed by the 3GPP standards organization. The E-UMTS system can also be referred to as a Long-Term Evolution (LTE) system.

The E-UMTS network can roughly be divided into an Evolved Universal Terrestrial

Radio Access Network (E-UTRAN) and a Core Network (CN). The E-UTRAN generally comprises a terminal (i.e., User Equipment (UE)), a base station (i.e., eNode B), and an Access Gateway (AG) that is located at an end of the E-UMTS network and connects with one or more external networks. The AG may be divided into a part for processing user traffic and a part for handling control traffic. Here, an AG for processing new user traffic and an AG for processing control traffic can be communicated with each other by using a new interface. One eNode B may have one or more cells. An interface for transmitting the user traffic or the control traffic may be used among the eNode Bs. The CN may comprise an AG, nodes for user registration of other UEs, and the like. An interface may be used to distinguish the E-UTRAN and the CN from each other.

Radio interface protocol layers between the terminal and the network can be divided into a first layer (L1), a second layer (L2) and a third layer (L3) based on three lower layers of an Open System Interconnection (OSI) standard model widely known in communications systems. A physical layer belonging to the first layer provides an information transfer service using a physical channel. A Radio Resource Control (RRC) layer located at the lowest portion of the third layer controls radio resources between the terminal and the network. For this purpose, the RRC layer allows RRC messages to be exchanged between the terminal and the network.

FIG. 2 shows radio interface protocol architecture between a terminal and E-UTRAN based on 3GPP radio access network standards. The radio interface protocol in FIG. 2 have horizontal layers comprising a physical layer, a data link layer and a network layer, and has vertical planes comprising a user plane for transmitting user traffic and a control plane for transmitting control signals. The protocol layers in FIG. 2 can be divided into a first layer (L1), a second layer (L2) and a third layer (L3) based on three lower layers of an Open System Interconnection (OSI) standard model widely known in communications systems. Hereinafter, each layer in the radio protocol architecture in FIG. 2 will be described.

A first layer, as a physical layer, provides an information transfer service to an upper layer using a physical channel. The physical layer is connected to its upper layer, called a Medium Access Control (MAC) layer, via a transport channel. The MAC layer and the physical layer exchange data via the transport channel. Data is transferred via a physical channel between different physical layers, namely, between the physical layer of a transmitting side and the physical layer of a receiving side. The physical channel is modulated based on an Orthogonal Frequency Division Multiplexing (OFDM) technique, and utilizes time and frequency as radio resources.

The MAC layer located at the second layer provides a service to an upper layer, called a Radio Link Control (RLC) layer, via a logical channel. The RLC layer of the second layer supports reliable data transmissions. The function of the RLC layer may be implemented as a functional block in the MAC layer. In this case, the RLC layer may not exist. A Packet Data Convergence Protocol (PDCP) layer of the second layer, in the radio protocol user plane, is used to efficiently transmit IP packets, such as IPv4 or IPv6, on a radio interface with a relatively narrow bandwidth. For this purpose, the PDCP layer reduces the size of an IP packet header which is relatively great in size and includes unnecessary control information, namely, a function called header compression is performed.

A Radio Resource Control (RRC) layer located at the lowest portion of the third layer is only defined in the control plane. The RRC layer controls logical channels, transport channels and physical channels in relation to establishment, re-configuration and release of Radio Bearers (RBs). Here, the RB signifies a service provided by the second layer for data transmissions between the terminal and the E-UTRAN. If an RRC connection is established between the RRC layer of the terminal and the RRC layer of the radio network, the terminal is in the RRC connected mode. Otherwise, the terminal is in an RRC idle mode.

A Non-Access Stratum (NAS) layer located at an upper portion of the RRC layer performs functions, such as session management, mobility management and the like.

One cell constructing an eNB is set to one of bandwidths of 1.25 MHz, 2.5 MHz, 5 MHz, 10 MHz, 20 MHz and the like, so as to provide downlink or uplink transmission services to multiple terminals. Here, different cells may be set to provide different bandwidths.

Downlink transport channels for transmitting data from a network to a terminal may comprise a Broadcast Channel (BCH) for transmitting system information, a Paging Channel (PCH) for transmitting paging messages and a downlink Shared Channel (SCH) for transmitting other user traffic or control messages. Traffic or control messages of a downlink point-to-multipoint service (multicast or broadcast service) may be transmitted either via a downlink SCH, or via a separate downlink Multicast Channel (MCH). In addition, uplink transport channels for transmitting data from a terminal to a network may comprise a Random Access Channel (RACH) for transmitting an initial control message and an uplink Shared Channel (SCH) for transmitting user traffic or control messages.

Logical channels which are located at an upper portion of transport channels and mapped to the transport channels include a Broadcast Control Channel (BCCH), a Paging Control Channel (PCCH), a Common Control Channel (CCCH), a MBMS point-to-multipoint Control Channel/Multicast Control Channel (MCCH), a MBMS point-to-multipoint Traffic Channel/Multicast Traffic Channel (MTCH), and the like.

FIG. 3 shows a transmission on a control channel according to the related art.

A physical channel is composed of multiple sub-frames arranged on a time axis and multiple sub-carriers arranged on a frequency axis. Here, a single sub-frame includes a plurality of symbols on the time axis. One sub-frame is composed of a plurality of resource blocks, each of which includes a plurality of symbols and a plurality of sub-carriers. Also, each sub-frame can use particular sub-carriers of particular symbols (e.g., a first symbol) at the corresponding sub-frame for a Physical Downlink Control Channel (PDCCH), namely, a L1/L2 control channel. One sub-frame is time duration of 0.5 ms. A Transmission Time Interval (TTI) as a unit time for which data is transmitted is 1 ms corresponding to two sub-frames.

FIG. 4 is a block diagram of a network structure for a cell broadcast service. As illustrated in FIG. 4, CBS messages originate in a plurality of cell broadcast entities (hereinafter abbreviated CBEs) connected to a cell broadcast center (hereinafter abbreviated CBC). The CBE separates the CBS message into a plurality of pages. The CBC is one node of a core network that performs a scheduling function by managing the CBS message. Iu-BC is an interface defined between the CBC and the RNC using a service area broadcast protocol (hereinafter abbreviated SABP). The CBC can give the RNC a broadcast order for a new message or enable a previous broadcast message to be modified or terminated using the SABP. The RNC performs a scheduling function for a CBS message delivered by the CBC and a broadcasting function to transmit the message to a specific cell using a BMC protocol. The RNC has a broadcast/multicast inter-working function (hereinafter abbreviated BMC-IWF) above a BMC layer to perform an interpreting function for a message and information delivered from the CBC. The UE receives a CBS message broadcast by the UTRAN. Examples of BMC messages used in the BMC protocol are a CBS message delivering user information, a schedule message facilitating reception of a CBS message by a UE and a CBS41 message delivering a short message delivered from an ANSI41 network. All the messages are transmitted from the UTRAN to the UE in uni-direction through a logical channel such as CTCH (Common Traffic Channel). The UE can reduce its battery consumption by performing a discontinuous reception (hereinafter abbreviated DRX) using information in the schedule message transmitted by the UTRAN through CTCH (Common Traffic Channel).

In a conventional art, after receiving a warning message, a mobile terminal compares a message identifier and a serial number of the received warning message with a message identifier and a serial number of previously stored warning message. Then, if values (i.e., a message identifier and a serial number) between the previously stored warning message and the currently received warning message are different, the currently received warning message is considered as an updated warning message. However, in conventional art, the mobile terminal can determine an existence of updated warning message only after receiving the warning message. Therefore, in case that the warning message is not updated, the mobile terminal must perform a reception of the warning message, and this causes a great drawback of wasting unnecessary usage of the mobile terminal's power consumption.

### DISCLOSURE OF INVENTION

### Solution to Problem

The present invention is to provide a method for efficiently receiving or transmitting an updated warning message.

To implement at least the above feature in whole or in parts, the present invention may provide a method of receiving a warning message in mobile communication system, the method comprising: receiving system information block (SIB) from a network through a broadcast control channel (BCCH); obtaining update information for the warning message from the received system information block; comparing the obtained update information for the warning message with a pre-stored update information in a mobile terminal; and receiving the warning message from the network, if the obtained update information is different from the pre-stored update information in the mobile terminal.

Also, in order to achieve at least the above feature in whole or in parts, the present invention may provide a method of transmitting a warning message in mobile communication system, the method comprising: transmitting system information block (SIB) through a broadcast control channel (BCCH), wherein update information for the warning message is obtained by a mobile terminal using the transmitted system information block, and wherein the obtained update information for the warning message is compared with a pre-stored update information in the mobile terminal; and transmitting the warning message to the mobile terminal, if the obtained update information is different form the pre-stored update information in the mobile terminal.

Also, the present invention may provide a mobile terminal that receives a warning message in mobile communication system, the mobile terminal comprising: a transceiver adapted to receive system information block (SIB) through a broadcast control channel (BCCH); and a processor cooperating with the transceiver to perform the steps of, obtaining update information for the warning message from the received system information block; comparing the obtained update information for the warning message with a pre-stored update information; and receiving the warning message from a network, if the obtained update information is different from the pre-stored update information.

Additional features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF DRAWINGS

FIG. 1 shows an exemplary network structure of an Evolved Universal Terrestrial

Radio Access Network (E-UTRAN) as a mobile communication system to which a related art and the present invention are applied;

FIG. 2 shows a radio interface protocol architecture between a terminal and a Evolved UMTS Terrestrial Radio Access Network (E-UTRAN) based on 3GPP radio access network standards;

FIG. 3 shows an exemplary view of a related art physical channel structure for control channel transmission;

FIG. 4 shows an exemplary block diagram of a network structure for a cell broadcast service; and

FIG. 5 shows a public warning system (PWS) transmission process according to a present invention.

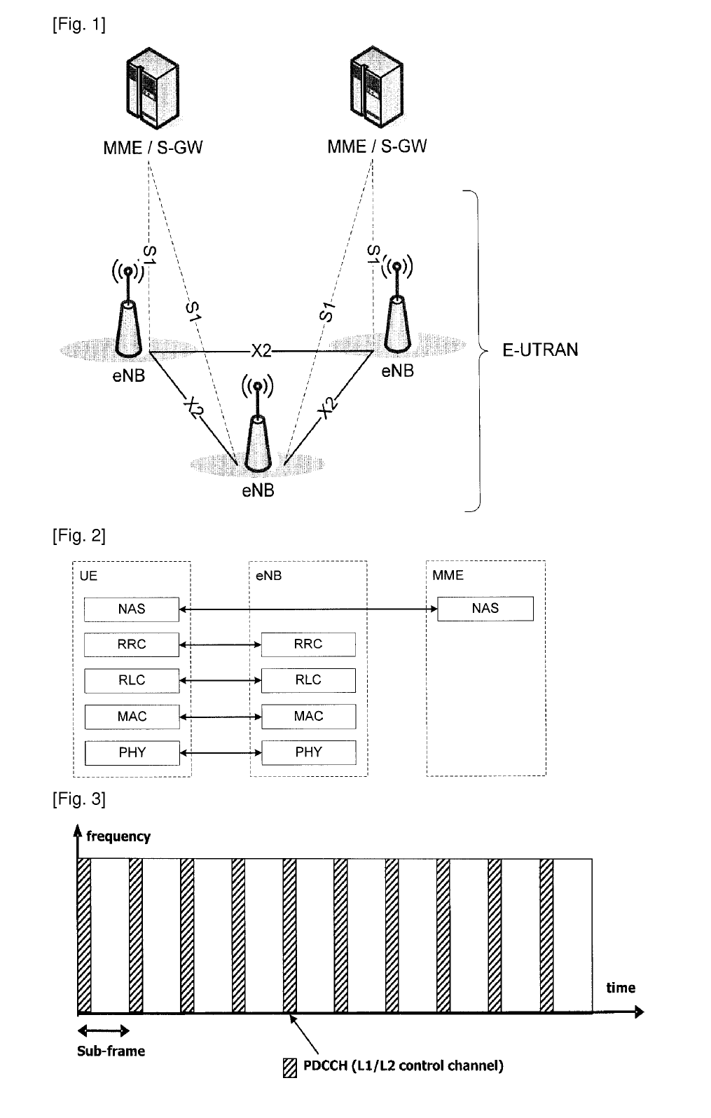

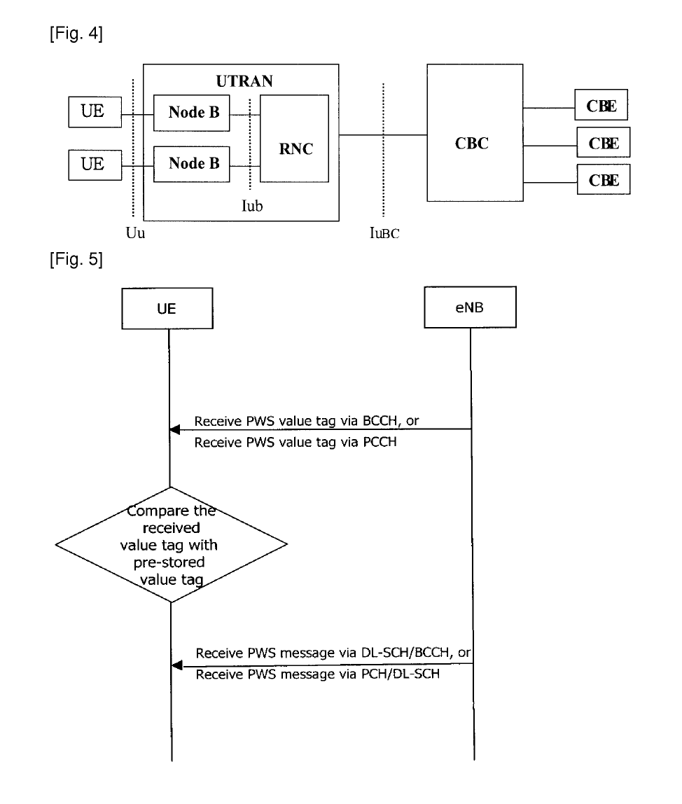

### MODE FOR THE INVENTION

One aspect of the present invention is the recognition by the present inventors regarding the problems and drawbacks of the related art described above and explained in more detail hereafter. Based upon such recognition, the features of the present invention have been developed.

The present invention may be embodied in a 3GPP communication technology, in particular, in the Universal Mobile Telecommunications System (UMTS) system, a communication apparatus and method thereof. However, the present invention may also be applied to all wired/wireless communications to which the technical scope of the present invention can be applied.

Hereinafter, description of structures and operations of the preferred embodiments according to the present invention will be given with reference to the accompanying drawings.

FIG. 5 shows a public warning system (PWS) transmission process according to a present invention. In the present invention, a warning message (i.e., PWS message) may be transmitted though a broadcast control channel (BCCH), which is a logical channel broadcasting system information to a plurality of terminals, or may be transmitted though a downlink transport channel, such as a downlink shared channel (DL-SCH).

As illustrated in FIG. 5, in a first step, a mobile terminal (UE) may receive a PWS dedicated value tag through system information (SI). Here, the system information may be received through a broadcast control channel (BCCH), and the PWS dedicated value tag is only used to inform an update of the warning message (PWS message or any disaster warning message). When the PWS dedicated value tag is transmitted through the system information, the PWS dedicated value tag may be transmitted through a system information block type 1 (SIB Type 1). Here, the SIB Type 1 may be transmitted through the logical channel (i.e., BCCH) and/or the transport channel (i.e., DL-SCH). In general, another value tag indicating an update of general system information, which is different from the PWS dedicated value tag, may be transmitted to the plurality of terminals through the system information. And, such value tag indicating the update of the general system information may also be transmitted through the SIB Type 1. Accordingly, in the present invention, two different type of value tags can be broadcast through the SIB Type 1.

Usually, the mobile terminal stores a PWS dedicated value tag for updating a warning message as well as a value tag for updating system information. After receiving of the current PWS dedicated value tag, the mobile terminal compares a prestored PWS dedicated value tag with the currently received PWS dedicated value tag if the pre-stored PWS dedicated value tag is already stored in the mobile terminal.

After comparison, if the current PWS dedicated value tag is different from the prestored PWS dedicated value tag, the mobile terminal acknowledges that there is an update of the warning message. In contrast, if the current PWS dedicated value tag is same as the pre-stored PWS dedicated value tag, the mobile terminal acknowledges that there is no update of the warning message.

In a second step, if the mobile terminal acknowledges the update of the warning message, the mobile terminal may receive the PWS message through a system information block. Here, the PWS message is the updated warning message (or updated disaster warning message). Further, the updated warning message may also be received through a downlink shared channel (DL-SCH) or a broadcast channel (BCH). During the above process, if no update of the warning message is acknowledged by the mobile terminal, the mobile does not receive the PWS message though the system information block. Thereafter, the mobile terminal checks a next PWS dedicated value tag occurring in a next period for the update of the warning message.

According to the present invention, a PWS dedicated value tag may also be transmitted to a mobile terminal through a paging message. Here, the paging message may be transmitted through a paging control channel (PCCH)

As described above, after receiving of the current PWS dedicated value tag through the paging message, the mobile terminal compares a pre-stored PWS dedicated value tag with the currently received PWS dedicated value tag.

After comparison, if the current PWS dedicated value tag received through the paging message is different from the pre-stored PWS dedicated value tag, the mobile terminal acknowledges that there is an update of the warning message. In contrast, if the current PWS dedicated value tag received through the paging message is same as the pre-stored PWS dedicated value tag, the mobile terminal acknowledges that there is no update of the warning message.

Then, if the mobile terminal acknowledges the update of the warning message, the updated warning message may also be received through a paging channel (PCH) or a downlink shared channel (DL-SCH). During the above process, if no update of the warning message is acknowledged by the mobile terminal, the mobile does not receive the PWS message. Thereafter, the mobile terminal checks a next PWS dedicated value tag occurring in a next period for the update of the warning message.

As aforementioned, in order to effectively use a power of mobile terminal, the mobile terminal, which attempts to receive the warning message (or disaster warning message), receives a broadcast control channel (BCCH) within a corresponding cell, obtains update information for the warning message through the received BCCH, determine whether the warning message has been updated according to the obtained update information, and receives the updated warning message if the warning message is determined to be updated. Here, the updated information is a value tag, which is incremented by 1 whenever the warning message is updated. The value tag is a dedicated value tag only used for indicating the update of the warning message. The warning message is a public warning system (PWS) message of 3GPP, and the 3GPP public warning system (3GPP PWS) is a generic service. An earthquake and tsunami warning system (ETWS) is a regional (Europe, Japan) variant of the PWS, and a commercial mobile alert system (CMAS) is US variant of the PWS. The ETWS is standardized in 3GPP, and the ETWS has additional broadcasting capabilities. The CMAS is a public warning system (PWS) that delivers warning notifications provided by warning notification providers to CMAS capable PWS-UEs. The CMAS defines three different classes of warning notifications (presidential, imminent threat and child abduction emergency). Each class can be defined as following: Presidential Alerts-Alerts for all people related to national emergencies, such as terrorist attacks, that will preempt any other pending alerts; Imminent Threat Alerts-Alerts with information on emergencies, such as hurricanes or tornadoes, where life or property is at risk, the event is likely to occur, and some responsive action should be taken; and Child Abduction Emergency/AMBER Alerts-Alerts related to missing or endangered children due to an abduction or runaway situation. The CMAS functionality does not require modifications to the 3GPP-defined cell broadcast functionality.

The present invention may provide a method of receiving a warning message in mobile communication system, the method comprising: receiving system information block (SIB) from a network through a broadcast control channel (BCCH); obtaining update information for the warning message from the received system information block; comparing the obtained update information for the warning message with a prestored update information in a mobile terminal; and receiving the warning message from the network, if the obtained update information is different from the pre-stored update information in the mobile terminal, wherein the warning message is received from the network through a downlink shared channel (DL-SCH), the warning message received from the network is an updated warning message, the warning message is a public warning system (PWS) message such as an Earthquake and Tsunami Warning System (ETWS) message or a commercial mobile alert system (CMAS) message, the update information is a value tag dedicated for updating the warning message, the value tag is incremented by 1 whenever the warning message is updated, and the received system information block is a SIB type 1.

It can be also said that the present invention may provide a method of transmitting a warning message in mobile communication system, the method comprising: transmitting system information block (SIB) through a broadcast control channel (BCCH), wherein update information for the warning message is obtained by a mobile terminal using the transmitted system information block, and wherein the obtained update information for the warning message is compared with a pre-stored update information in the mobile terminal; and transmitting the warning message to the mobile terminal, if the obtained update information is different form the pre-stored update information in the mobile terminal, wherein the warning message is transmitted to the mobile terminal through a downlink shared channel (DL-SCH), the warning message is a public warning system (PWS) message such as an Earthquake and Tsunami Warning System (ETWS) message or a commercial mobile alert system (CMAS) message, the update information is a value tag dedicated for updating the warning message, and the received system information block is a SIB type 1.

Also, the present invention may also provide a mobile terminal that receives a warning message in mobile communication system, the mobile terminal comprising: a transceiver adapted to receive system information block (SIB) through a broadcast control channel (BCCH); and a processor cooperating with the transceiver to perform the steps of, obtaining update information for the warning message from the received system information block; comparing the obtained update information for the warning message with a pre-stored update information; and receiving the warning message from a network, if the obtained update information is different from the pre-stored update information.

Although the present invention is described in the context of mobile communications, the present invention may also be used in any wireless communication systems using mobile devices, such as PDAs and laptop computers equipped with wireless communication capabilities (i.e. interface). Moreover, the use of certain terms to describe the present invention is not intended to limit the scope of the present invention to a certain type of wireless communication system. The present invention is also applicable to other wireless communication systems using different air interfaces and/or physical layers, for example, TDMA, CDMA, FDMA, WCDMA, OFDM, EV-DO, Wi-Max, Wi-Bro, etc.

The exemplary embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.).

Code in the computer readable medium may be accessed and executed by a processor. The code in which exemplary embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A method of receiving a warning message in mobile communication system, the method comprising:
receiving system information block (SIB) from a network through a broadcast control channel (BCCH);
obtaining update information for the warning message from the received system information block;
comparing the obtained update information for the warning message with a pre-stored update information in a mobile terminal; and
receiving the warning message from the network, if the obtained update information is different from the pre-stored update information in the mobile terminal.

2. The method of claim 1, wherein the warning message is received from the network through a downlink shared channel (DL-SCH).

3. The method of claim 1, wherein the warning message received from the network is an updated warning message.

4. The method of claim 1, wherein the warning message is a public warning system (PWS) message that is either an Earthquake and Tsunami Warning System (ETWS) message or a commercial mobile alert system (CMAS) message.

5. The method of claim 1, wherein the update information is a value tag dedicated for updating the warning message.

6. The method of claim 5, wherein the value tag is incremented by 1 whenever the warning message is updated.

7. The method of claim 1, wherein the received system information block is a SIB type 1.

8. A mobile terminal that receives a warning message in mobile communication system, the mobile terminal comprising:
a transceiver adapted to receive system information block (SIB) through a broadcast control channel (BCCH); and
a processor cooperating with the transceiver to perform the steps of, obtaining update information for the warning message from the received system information block;
comparing the obtained update information for the warning message with a pre-stored update information; and
receiving the warning message from a network, if the obtained update information is different from the pre-stored update information.

9. The mobile terminal of claim 8, wherein the warning message is received from the network through a downlink shared channel (DL-SCH).

10. The mobile terminal of claim 8, wherein the warning message received from the network is an updated warning message.

11. The mobile terminal of claim 8, wherein the warning message is a public warning system (PWS) message that is either an Earthquake and Tsunami Warning System (ETWS) message or a commercial mobile alert system (CMAS) message.

12. The mobile terminal of claim 8, wherein the update information is a value tag dedicated for updating the warning message.

13. The mobile terminal of claim 12, wherein the value tag is incremented by 1 whenever the warning message is updated.

14. The mobile terminal of claim 8, wherein the received system information block is a SIB type 1.
